(19) United States
(12) Patent Application Publication
(10) Pub. No.: US 2025/0086100 A1
(43) Pub. Date: Mar. 13, 2025

(54) AUTONOMOUS VEHICLE DRIVING DATA

(71) Applicant: TuSimple, Inc., SAN DIEGO, CA (US)

(72) Inventors: Dantong DONG, San Diego, CA (US); Yixin YANG, San Diego, CA (US); Yuxuan LUO, Charlotte, NC (US); Ao LIU, San Diego, CA (US); Weiqi XU, San Diego, CA (US); Yunyi YANG, San Diego, CA (US); Shen QU, San Diego, CA (US); Junbo JING, San Diego, CA (US); Yan ZHUANG, San Diego, CA (US)

(21) Appl. No.: 18/827,189

(22) Filed: Sep. 6, 2024

Related U.S. Application Data
(60) Provisional application No. 63/582,154, filed on Sep. 12, 2023.

(51) Int. Cl. G06F 11/36; B60W 50/14; G06V 20/70

(52) U.S. Cl. CPC G06F 11/3692; B60W 50/14; G06V 20/70; B60W 2050/146

(57) ABSTRACT

Techniques are described for analyzing autonomous vehicle driving. An example technique includes receiving, by a computer, a set of data from a software that performs driving related operations for an autonomous vehicle; generating a plurality of frames using the timestamps associated with the set of data; determining, for each frame, that the at least one data indicates information related to the autonomous vehicle and/or the one or more objects; assigning, for each frame, a label associated with the information indicated by the at least one data; and displaying, using a graphical user interface (GUI) and for the test performed with the software, at least one label associated with at least one information in a frame.

### CROSS-REFERENCE TO RELATED APPLICATIONS

This document claims priority to and the benefit of U.S. Provisional Application No. 63/582,154, filed on Sep. 12, 2023. The aforementioned application of which is incorporated herein by reference in its entirety.

### TECHNICAL FIELD

This document relates to systems, apparatus, and methods to label or validate autonomous driving related data.

### BACKGROUND

Autonomous vehicle navigation is a technology that can allow a vehicle to sense the position and movement of vehicles around an autonomous vehicle and, based on the sensing, control the autonomous vehicle to safely navigate towards a destination. An autonomous vehicle may operate in several modes. In some cases, an autonomous vehicle may allow a driver to operate the autonomous vehicle as a conventional vehicle by controlling the steering, throttle, clutch, gear shifter, and/or other devices. In other cases, a driver may engage the autonomous vehicle navigation technology to allow the vehicle to be driven by itself.

### SUMMARY

When an autonomous vehicle is driven on a road or when a simulation is performed for the autonomous vehicle driven on the road, the driving-related operations of the autonomous vehicle and/or characteristics of one or more objects (e.g., traffic light, other vehicles) located around the autonomous vehicle can be determined using timestamped data collected by the autonomous vehicle. The driving-related operations of the autonomous vehicle (e.g., performing lane changes, applying brakes to stop within a certain distance) can also be validated by comparing actual or simulated performance of the autonomous vehicle against a desired performance requirement. The determined driving-related operations of the autonomous vehicle, the determined characteristic of one or more objects, and/or the validation of the driving-related operations can be technically advantageous to test software or updates to software employed on autonomous vehicle operating on the road.

An example method of analyzing autonomous vehicle driving comprises receiving, by a computer, a set of data from a software that performs driving related operations for an autonomous vehicle, where the set of data includes a first set of data related to an autonomous vehicle that operated on a road and a second set of data related to one or more objects located in an environment where the autonomous vehicle operated, where the set of data is associated with timestamps, and where the set of data is received as part of a test performed with the software; generating a plurality of frames using the timestamps associated with the set of data, wherein each frame includes at least one data from the set of data, and wherein each frame is associated with a unique timestamp; determining, for each frame, that the at least one data indicates information related to the autonomous vehicle and/or the one or more objects. Operation 508 includes assigning, for each frame, a label associated with the information indicated by the at least one data; and displaying, using a graphical user interface (GUI) and for the test performed with the software, at least one label associated with at least one information in a frame.

In some embodiments, the first set of data is associated with the autonomous vehicle that is operated on the road in a simulation, and the second set of data is associated with the one or more objects that are simulated in the simulation. In some embodiments, the method further comprises determining that the software is validated upon determining that a driving related operation of the autonomous vehicle indicated by the at least one label in the frame is a same as or meets a pre-determined performance requirement. In some embodiments, the method further comprises determining that the information indicated by the at least one data in each frame is associated with a static label or a dynamic label, where the label for the information is assigned based on whether the information is associated with the static label or the dynamic label. In some embodiments, in response to the information being associated with the static label, the label for the information is assigned by determining that the information in the frame is described by or related to a first rule from a database that stores the label and the first rule associated with the label.

In some embodiments, the label for the information associated with the static label is assigned without performing a simulation with a scenario. In some embodiments, in response to the information being associated with the dynamic label, the label for the information is assigned by determining that the information in at least two frames comprising the frame is described by or related to a second rule from a database that stores the label and the second rule associated with the label. In some embodiments, the label for the information is assigned using computation resources that are assigned based on whether the information indicated by the at least one data in each frame is associated with the static label or the dynamic label. In some embodiments, a number of the computation resources assigned for the information associated with the static label is less than that assigned for the information associated with the dynamic label.

In some embodiments, the at least one data in each frame is determined to include the information related to the autonomous vehicle and/or the one or more objects by performing keyword search on the at least one data in each frame. In some embodiments, the first set of data include driving related operations of the autonomous vehicle. In some embodiments, the second set of data related to at least one object includes a speed of the at least one object, a location of the at least one object, or a distance from the autonomous vehicle of the at least one object. In some embodiments, the method further comprises storing in a database a plurality of labels and a plurality of rules, wherein each label is stored with a corresponding rule that indicates a content of a data or a pattern of the data associated with that label. In some embodiments, the method further comprises determining, from the plurality of frames, a set of frames that comprise a topic indicative of a driving related operation of the autonomous vehicle.

In some embodiments, the method further comprises determining, from the plurality of frames, a set of frames that comprise a topic indicative of a driving related operation of a vehicle located in the environment where the autonomous vehicle operated. In some embodiments, the method further comprises determining, from the plurality of frames, a set of frames that comprise a topic indicative of a characteristic of an object located in the environment where the autonomous vehicle operated, wherein the one or more objects comprise the object. In some embodiments, the method further comprises determining, from the plurality of frames, a set of frames that comprise a topic indicative of a characteristic of the road on which the autonomous vehicle operated. In some embodiments, the method further comprises determining that a set of information related to an object from the one or more objects is related to another set of information related to the object in another frame.

In yet another exemplary aspect, the above-described method is embodied in a non-transitory computer readable storage medium comprising code that when executed by a processor, causes the processor to perform the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example block diagram for labeling simulated autonomous driving related data and/or actual autonomous driving related data.

FIG. 2 shows an example flowchart of operations performed by a simulation module to process simulation data and/or actual driving operation data.

FIG. 3 shows an example flowchart of operations performed by a simulation module to determine state information of an autonomous vehicle and/or one or more objects located around the autonomous vehicle.

FIG. 4 shows a set of operations performed by a simulation module to identify static labels and dynamic labels and/or schedules computation resources.

FIG. 5 shows a flowchart for analyzing autonomous driving related data.

FIG. 6 shows an exemplary block diagram of a computer that processes simulation data and/or actual driving operation data.

### DETAILED DESCRIPTION

Developments in autonomous driving technology have led to a development of vehicles that can drive themselves to a destination without much involvement from a driver, where the vehicles are driven using information obtained from sensors located on the vehicle. For a vehicle to operate in an autonomous mode, engineers have developed autonomous driving software that can instruct the vehicle to perform driving related operations to drive along a trajectory and/or to avoid causing accident with one or more objects (e.g., other vehicles, pedestrians) located around the vehicle. An autonomous driving software generates a data log as part of a simulation or as part of an actual driving operation on a road. One of the technical problems with autonomous driving software that the generated data log is difficult for a human to comprehend, and a human can easily overlook issues with performance of the autonomous vehicle indicated in the data log. Another technical problem with the data log generated by the autonomous driving software is that a person has to manually label to identify relevant content in the data log.

Using the techniques described in this patent document, the autonomous driving software can be tested on an autonomous vehicle in real-time on a private road, or the autonomous driving software can be tested via a simulation where driving-related real operations of a simulated vehicle can be tested. When an autonomous vehicle driving operation is simulated, the simulation produces an output a data log that indicates driving-related operations performed by the simulated vehicle, where each driving-related operation can be associated with a timestamp. The characteristics of one or more simulated objects located around the simulated vehicle can also be determined and can be included in the data log. As mentioned above, the data log can be difficult for a human to understand and/or label at least because the data log is very long (e.g., may include thousands of lines of data and/or code) and includes machine code that is not readable by humans.

To address at least the technical problems mentioned above, this patent document describes techniques to label behavioral data and perception data by analyzing data log and/or validate a simulated or actual autonomous driving operation based on analyzing the information in the data log. An example of behavioral data is to determine whether a car is traveling at a certain speed, and an example of perception data is to determine that a car is located at a certain distance from the autonomous vehicle. This patent document also describes techniques to validate simulated autonomous driving operations by comparing data from data log against a performance requirement (e.g., simulated steering angle value is less than a pre-determined required value). One of the technical benefits of the labeling technique described in this patent document is that it can analyze data from the data log and output labels that characterize the data. static

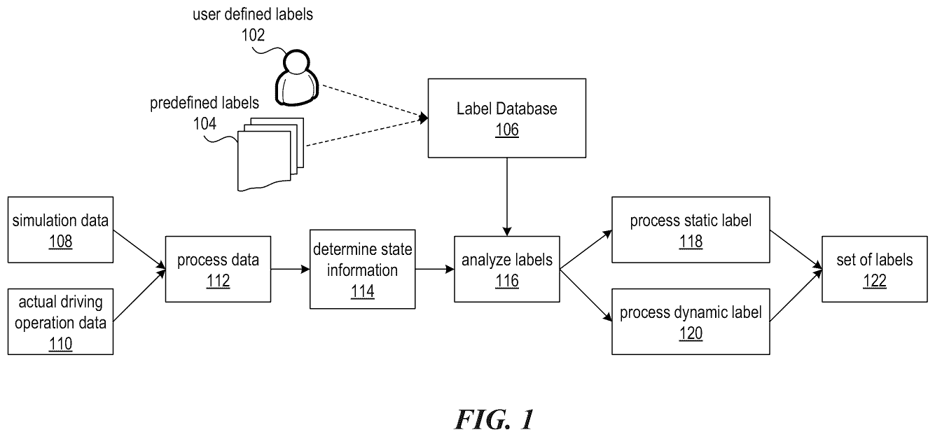

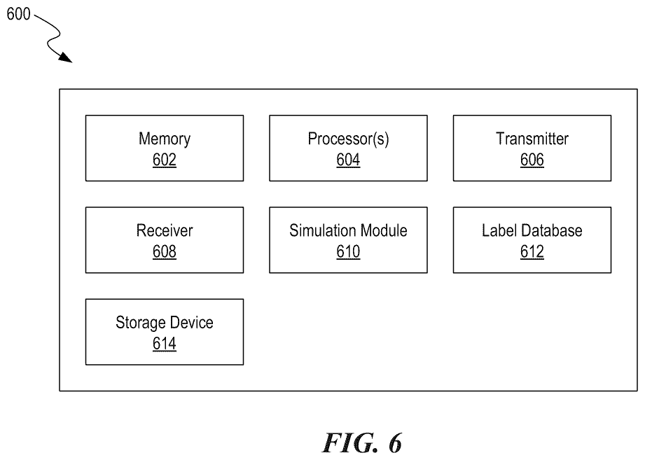

FIG. 1 shows an example block diagram for labeling simulated autonomous driving related data and/or actual autonomous driving related data. A label database 106 (also shown as 612 in FIG. 6) may store predefined labels 104 and/or user defined labels 102. The label database 106 may store a rule for each label, where the rule identifies a content of data or a pattern of data associated with that label, and where the rule identifies whether the label is a static label or a dynamic label. For example, a label can be “cut-in allowed” for which a rule states that the data include the words “lane cut-in allowed” or something similar to indicate that the data indicates that other vehicles are allowed to cut in a same lane as and in front of an autonomous vehicle. In this example, the “cut-in allowed” label is associated with a dynamic label in the label database 106. In another example, another label can be “hard brake” for which a rule states that the data indicates that another vehicle in front of the autonomous vehicle had a first speed greater than a certain value at a first time, and the another vehicle has a second speed of zero mph at a second time, where a time difference between the first time and the second time is less than or equal to a pre-determined value. For this example, the label “hard brake” can be associated with a dynamic label in the label database 106. An example of a static label may be a traffic sign, and its associated rule may be an identifier or words indicating a presence of a traffic sign in the data. The user defined labels 102 may be entered by a user into the label database 106, where a user can enter a name of a label and an associated rule. A technical benefit of having a user defined label is that a user can adjust the labels based on specific usage and/or needs of the user.

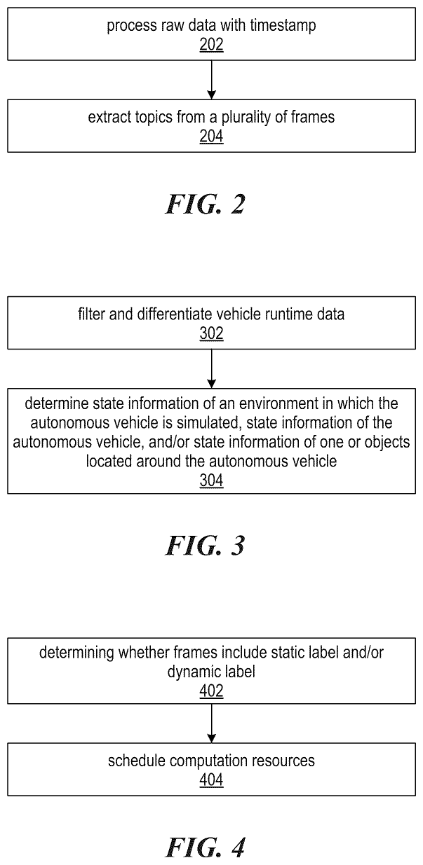

A simulation module (shown as 610 in FIG. 6) can process data 112 by processing the simulation data 108 and/or actual driving operation data 110. FIG. 2 shows an example flowchart of operations performed by a simulation module to process simulation data 108 and/or actual driving operation data as part of a process data 112 operation. At operation 202, the simulation module can process raw data (e.g., simulation data 108 and/or actual driving operation data 110) segmenting the simulation data 108 and/or the actual driving operation data 110 into temporal (or time related) frames generated using the timestamp associated with the simulation data 108 and/or with the actual driving operation data 110. For example, the simulation module can include a set of data in a frame where the set of data is associated with one or more timestamps associated with one or more times. The simulation module can store in a storage device (shown as 614 in FIG. 6) a plurality of frames, where each frame includes a set of data from the simulation data 108 and/or with the actual driving operation data 110.

In some embodiments, the simulation module can segment the simulation data 108 and/or the actual driving operation data 110 at a specified frequency. For example, if the simulation module determines that a first set of data from the simulation data 108 and/or the actual driving operation data 110 is from a from a first algorithm or a first algorithm computation node, then the simulation module can segment the first set of data at a first frequency, and if the simulation module determines that a second set of data from the simulation data 108 and/or the actual driving operation data 110 is from a from a second algorithm or a second algorithm computation node, then the simulation module can segment the second set of data at a second frequency different from the first frequency. A technical benefit of having the simulation module perform the segmentation of the data at different frequencies is that each algorithm or each algorithm computation node operates on the autonomous vehicle at a different frequency (or is asynchronized) so that the simulation module can perform segment the set of data at different frequencies to synchronize the data.

In some embodiments and as part of the process data 112 operation, the simulation module can also perform operation 202 in FIG. 2 to extract and/or organize data from the plurality of frames according to topics (or runtime data of an object/autonomous vehicle). The simulation module can analyze the data from the plurality of frames to identify data indicative of one or more topics in the plurality of frames. For example, one topic may be “hard brake” where the simulation module stores one or more frames comprising data indicative of hard brakes applied by an autonomous vehicle or by one or more vehicles around the autonomous vehicle. In this example, the simulation module can determine a presence of code indicative of hard braking in the plurality of frames and identify and compile the one or more frames comprising that topic. In another example, another topic may be “construction zone” where the simulation module stores one or more frames comprising data that indicates that the autonomous vehicle is driving through a construction zone. In this example, the simulation module can determine a presence of code or words indicative of a construction zone though which the autonomous vehicle is being driven and identify and compile the one or more frames comprising that topic.

Next, in FIG. 1 and as further explained in FIG. 3 below, the simulation module can determine state information 114 of an autonomous vehicle and/or one or more objects located around (e.g., front, back, or side of) the autonomous vehicle from the plurality of frames obtained from the process data 112 operation. In some embodiments, the state information may include external state information that includes characteristics (e.g., speed, a location, GPS coordinates, distance from autonomous vehicle to object) about one or more objects (e.g., other vehicles, traffic light, lanes) located around the autonomous vehicle with which a simulation is performed. In some embodiments, the state information may include internal state information that includes information about an autonomous vehicle with which the simulation is performed. The internal state information about the autonomous vehicle may include the following example characteristics/driving related operations related to the autonomous vehicle: current speed, current steering angle, amount of brakes applied, current gear, current location, stay in a lane, perform lane change, cancel performing lane change, swerve or turn, accept merge in from another vehicle, merge lane, perform, perform throttle, apply brakes, apply steering angle, etc.

FIG. 3 shows an example flowchart of operations performed by a simulation module to determine state information of an autonomous vehicle and/or one or more objects located around the autonomous vehicle as part of the determine state information 114 operation. The operations in FIG. 3 may not be performed in any particular order, and certain operations can be skipped. At operation 302, the simulation module can filter and differentiate vehicle runtime data by determining from the plurality of frames of data, a subset of data related to the autonomous vehicle with which the simulation is performed and/or another subset of data related to one or more objects located around the autonomous vehicle.

At operation 304, the simulation module can determine state information of an environment in which the autonomous vehicle is simulated (e.g., maps, road, construction zone, etc.), state information of the autonomous vehicle (amount of brakes, steering angle, engine status/throttle, trajectory, etc.), and/or state information of one or objects located around the autonomous vehicle (e.g., location and speed of an external vehicle, location of pedestrian, lane on which a cyclist is located, etc.). In some embodiments, at operation 304, the simulation module can determine the state information of the autonomous vehicle and/or the one or more objects located around the autonomous vehicle from data in a frame by searching for pre-determined keywords associated with the autonomous vehicle and/or one or more objects.

In some embodiments, the simulation module can also determine whether the content in two or more frames are related. For example, if the simulation module determines that a first frame indicates a presence of car #1, and if the simulation module determines that car #1 is also indicated in a second frame that is immediately after the first frame in time, then the simulation module can determine that car #1 is included in both the first frame and the second frame and/or the simulation module can determine that the first frame and second frame are related with respect to car #1. Thus, in FIG. 1, the simulation module can perform operations associated with the process data 112 and determine state information 114 to reconstruct environmental information (e.g., information about one or more objects around the autonomous vehicle) and behavior information (e.g., driving related operations of the autonomous vehicle and/or one or more objects around the autonomous vehicle) from runtime simulation data 108 and/or actual driving operation data 110.

Next, the simulation module can analyze labels 116 by determining whether the state information in each of the plurality of frames is associated with a static label and/or a dynamic label, and by scheduling computation resources based on whether a frame includes a static label and/or dynamic label as shown in FIG. 4. Static label may be used for identifying static environment information such as map and road type. A static label can include map information or road infrastructure (e.g., lane, ramp, exit or entry, traffic sign, traffic light, no traffic light, stop sign, rail, construction zone, lane end, lane split, speed limit sign, carpool lane, etc.). A dynamic label can include information about the autonomous vehicle or external information of objects around the autonomous vehicle. For example, dynamic label can include a driving related operation of the autonomous vehicle (e.g., current speed, current gear, current location, stay in a lane, perform lane change, cancel performing lane change, swerve or turn, accept merge in from another vehicle, merge lane, perform, perform throttle, apply brakes, apply steering angle, etc.), In another example, a dynamic label can include external information of one or more objects located around the autonomous vehicle (e.g., a presence of an oversized vehicle, motorcycle, cyclist, pedestrian, emergency lane vehicle, non-compliant driver, emergency vehicle, unknown object, static object, stopped vehicle, etc.).

In FIG. 4, the simulation module can determine whether a frame includes a static label and/or a dynamic label by comparing state information (e.g., external state information and/or internal state information) in the frame for one or more objects or for the autonomous vehicle with one or more rules corresponding to one or more labels from the label database (shown as 106 in FIG. 1). In some embodiments, for each frame, the simulation module can determine whether the content included in the frame is associated with (e.g., is same as the content in) each of a plurality of rules for the plurality of labels from the label database. In such embodiments, if the simulation module determines that the frame includes content that is same as or related to a rule associated with a static label, then the simulation module associates that frame with that rule so that the simulation module determines that that frame includes state information associated with a static label. And, in such embodiments, if the simulation module determines that a frame is associated with a rule that is associated with a dynamic label, then the simulation module determines that that frame includes state information associated with a dynamic label. In some embodiments, if the simulation module determines that the frame (or information about an object/autonomous vehicle in the frame) is identified as being related to another frame (or information about the object/autonomous vehicle in the another frame) as explained in this patent document, then the simulation module determines that that frame includes state information associated with a dynamic label. In some embodiments, the simulation module may determine whether a frame includes a static label and/or a dynamic label by analyzing content of the state information in the frame.

At the analyze labels 116 operation, if the simulation module determines that a label is a static label, then the simulation module can determine to schedule computation resources that are less than if the simulation module determines that the label is a dynamic label. One reason for assigning higher computational resources to dynamic labels is that those labels can be determined in real-time after the simulation data 108 and/or actual driving operation data 110 are processed at the process data 112 operation. In some embodiments, dynamic label may be used for identifying dynamic information related to the autonomous vehicle or one or more objects located around the autonomous vehicle so that runtime data may be required to extract this type of label. For example, if the simulation module determines that a frame includes state information indicative of a presence of a traffic light, then the simulation module can allocate computation resources for a dynamic label to process traffic light related labels (e.g., flashing red light, skipping yellow light etc.) If a label has a duration requirement, the simulation module can use a temporal analyzer to augment or postprocess data and extract its label. Another reason for assigning lower computational resources to static labels is that runtime data may not be required to extract static labels, the simulation module can use heuristic rules to extract a rough estimate on vehicle runtime information to extract labels as further explained below in the process static labels operations 118.

Based on the type of label associated with a frame (e.g., static label and/or dynamic label), the simulation module can use different types of processes to process and to label potential events or object or autonomous vehicle indicated in the state information determined at operation 114. For example, if the simulation module determines that a first frame includes state information associated with a static label at the analyze labels 116 operation, then the simulation module can perform the process static label operation 118 by identifying a rule associated with that information from the first frame, where the rule is associated with a label, and where the simulation module assigns the label with the information from the first frame. In another example, if the simulation module determines that a second frame includes state information associated with a dynamic label at the analyze labels 116 operation, then the simulation module can perform the process dynamic label operation 120 by identifying a rule associated with that information from the second frame and/or from one or more additional frames, where the rule is associated with a label, and where the simulation module assigns the label with the information from the second frame and/or the one or more additional frames. The simulation module can determine, for each frame, one or more rules associated with data/information in a frame, and the simulation module can assign (or determine) one or more labels associated with the one or more rules for that frame. The simulation module may obtain a set of labels 122 that includes one or more labels associated each object or with the autonomous vehicle for each frame.

The simulation module can perform operations associated with process static label 118 and/or process dynamic label 120 using appropriate extensions to handle special cased labels. In some embodiments, the simulation module may not run a scenario for a static label (or may not use runtime data), and may instead use a heuristic rule (i.e., a pre-determined rule) to run runtime information to obtain static label from the state information determined at operation 114. In one example implementation, the simulation module can determine from a map that the autonomous vehicle will travel through a traffic intersection so that the simulation module can use a pre-determined rule associated with traffic intersection to determine a presence of a traffic light and/or pedestrians. In another example, at the process dynamic label 120 operation, the simulation module can use a temporal analyzer if the simulation module determines that the state information determined at operation 114 indicates a continuation of an event from one time stamp to at least another time stamp.

Next, the simulation module obtains or determines a set of labels 122 by performing the process static label 118 operation and/or the process dynamic label 120 operation. The set of labels 122 may be a plurality of labels that describe the characteristics or operations of the autonomous vehicle and/or one or more objects located around the autonomous vehicle as a function of time.

The techniques described in FIGS. 1-4 can allow the simulation module to automatically label perception data (e.g., a vehicle is located at a certain distance away from the autonomous vehicle) and behavioral data (e.g., the trajectory of the vehicle, lane change operation of the autonomous vehicle). In some embodiments, the simulation module can determine that the simulated autonomous vehicle's driving related operations are validated upon determining that a label associated with the autonomous vehicle's operation is the same as a desired performance requirement. For example, a simulation module can determine that the simulation data and/or actual driving operation data did not include code that indicates that the autonomous vehicle detected a speed limit on a road. A technical benefit of having a validation operation is that a human reading the raw data from the simulation data and/or actual driving operation data may easily miss that the autonomous vehicle did not detect the speed limit if the autonomous vehicle happened to operate at a speed less than the speed limit. The simulation module can validate or determine that the autonomous vehicle is operating as desired by comparing information (or lack of information) in simulation data and/or actual driving operation data against a pre-determined performance requirement.

In some embodiments, the techniques described in FIGS. 1-5 can be performed as an autonomous vehicle is actually operated on a road. In such embodiments, the actual driving operation data generated by a computer located in the autonomous vehicle can be subsequently analyzed and processed by the simulation module as the autonomous vehicle is operated on the road. In such embodiments, the computer located in the autonomous vehicle can send instructions to one or more devices in the autonomous vehicle (e.g., an instruction to a motor in the steering that causes the autonomous vehicle to steer, or another instruction to a brake system to apply brakes), so that the autonomous vehicle is caused to drive on the road or stop on or next to the road.

In some embodiments, a graphical user interface (GUI) can display on a screen/monitor one or more labels associated with each of a plurality of frames from the simulation data and/or actual driving operation data. In some embodiments, the GUI can display topics associated with the plurality of frames so that upon selection of a topic, the GUI can show a frame or a set of frames associated with the topic, where the frame or the set of frames are include data associated with a simulation performed with an autonomous vehicle. The GUI can display the label(s) and/or topic(s) (e.g., with a timestamp) is beneficial to help a user visualize the operation of the autonomous vehicle along with performance of the autonomous vehicle and/or any associated issues. In some embodiments, a user can select via the GUI a simulation to be run or played and the GUI can display label(s) and/or topic(s) as the simulation is run.

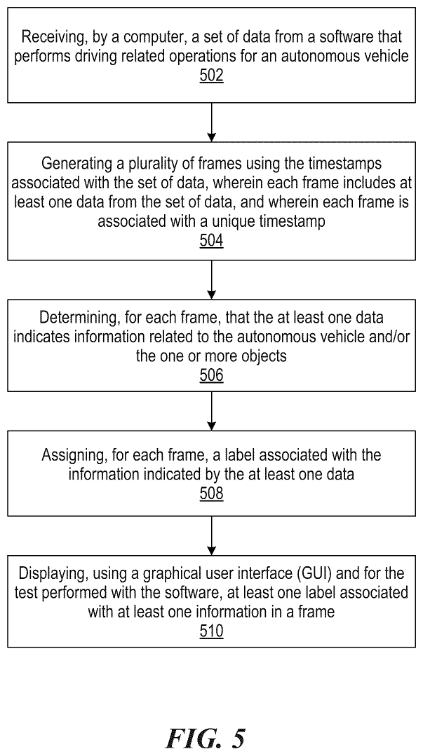

FIG. 5 shows a flowchart for analyzing autonomous driving related data. Operation 502 includes receiving, by a computer, a set of data from a software that performs driving related operations for an autonomous vehicle, where the set of data includes a first set of data related to an autonomous vehicle that operated on a road and a second set of data related to one or more objects located in an environment where the autonomous vehicle operated, where the set of data is associated with timestamps, and where the set of data is received as part of a test performed with the software. Operation 504 includes generating a plurality of frames using the timestamps associated with the set of data, wherein each frame includes at least one data from the set of data, and wherein each frame is associated with a unique timestamp. Operation 506 includes determining, for each frame, that the at least one data indicates information related to the autonomous vehicle and/or the one or more objects. Operation 508 includes assigning, for each frame, a label associated with the information indicated by the at least one data. Operation 510 includes displaying, using a graphical user interface (GUI) and for the test performed with the software, at least one label associated with at least one information in a frame.

In some embodiments, the first set of data is associated with the autonomous vehicle that is operated on the road in a simulation, and the second set of data is associated with the one or more objects that are simulated in the simulation. In some embodiments, the method further comprises determining that the software is validated upon determining that a driving related operation of the autonomous vehicle indicated by the at least one label in the frame is a same as or meets a pre-determined performance requirement. In some embodiments, the method further comprises determining that the information indicated by the at least one data in each frame is associated with a static label or a dynamic label, where the label for the information is assigned based on whether the information is associated with the static label or the dynamic label. In some embodiments, in response to the information being associated with the static label, the label for the information is assigned by determining that the information in the frame is described by or related to a first rule from a database that stores the label and the first rule associated with the label.

In some embodiments, the label for the information associated with the static label is assigned without performing a simulation with a scenario. In some embodiments, in response to the information being associated with the dynamic label, the label for the information is assigned by determining that the information in at least two frames comprising the frame is described by or related to a second rule from a database that stores the label and the second rule associated with the label. In some embodiments, the label for the information is assigned using computation resources that are assigned based on whether the information indicated by the at least one data in each frame is associated with the static label or the dynamic label. In some embodiments, a number of the computation resources assigned for the information associated with the static label is less than that assigned for the information associated with the dynamic label.

In some embodiments, the at least one data in each frame is determined to include the information related to the autonomous vehicle and/or the one or more objects by performing keyword search on the at least one data in each frame. In some embodiments, the first set of data include driving related operations of the autonomous vehicle. In some embodiments, the second set of data related to at least one object includes a speed of the at least one object, a location of the at least one object, or a distance from the autonomous vehicle of the at least one object. In some embodiments, the method further comprises storing in a database a plurality of labels and a plurality of rules, wherein each label is stored with a corresponding rule that indicates a content of a data or a pattern of the data associated with that label. In some embodiments, the method further comprises determining, from the plurality of frames, a set of frames that comprise a topic indicative of a driving related operation of the autonomous vehicle.

In some embodiments, the method further comprises determining, from the plurality of frames, a set of frames that comprise a topic indicative of a driving related operation of a vehicle located in the environment where the autonomous vehicle operated. In some embodiments, the method further comprises determining, from the plurality of frames, a set of frames that comprise a topic indicative of a characteristic of an object located in the environment where the autonomous vehicle operated, wherein the one or more objects comprise the object. In some embodiments, the method further comprises determining, from the plurality of frames, a set of frames that comprise a topic indicative of a characteristic of the road on which the autonomous vehicle operated. In some embodiments, the method further comprises determining that a set of information related to an object from the one or more objects is related to another set of information related to the object in another frame.

FIG. 6 shows an exemplary block diagram of a computer that processes simulation data and/or actual driving operation data. The computer 600 includes at least one processor 604 and a memory 602 having instructions stored thereupon. The instructions upon execution by the processor 604 configure the computer 600 to perform the operations described in FIGS. 1 to 5, the operations related to the simulation module 610, and/or the operations in the various embodiments described in this patent document. The transmitter 606 and receiver 608 may send and receive information, respectively. The label database 612 may store a plurality of labels and a plurality of associated rules. The storage device 614 may store a plurality of frames that include a plurality of data that may be extracted from simulation data and/or actual driving operation data.

In this document the term “exemplary” is used to mean “an example of” and, unless otherwise stated, does not imply an ideal or a preferred embodiment.

It will be appreciated by one of skill in the art that the present document discloses techniques that provide technical solutions and contribute to the advancement of the autonomous driving technology by allowing a human operator to efficiently review test data on a GUI. Autonomous vehicles produce a large amount of test data and, without the technical solutions provided in the present document, analysis of such data becomes inefficient and error-prone. By providing computer assisted time synchronicity and labeling of test data, a human user is assisted to navigate to a specific time duration or a specific functional aspect of autonomous driving. Further based on such an accurate analysis, the human user may be able to provide an input to a navigation algorithm that navigates the autonomous vehicle and/or be able to determine if software changes performed to the autonomous vehicle are providing a desired level of performance. Therefore, the technology disclosed in this document solves the practical problem of how to efficiently and accurately upgrade software of an autonomous vehicle controller, how to evaluate test data to ascertain that desired performance is being met, and so on.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of analyzing autonomous vehicle driving, comprising:
receiving, by a computer, a set of data from a software that performs driving related operations for an autonomous vehicle,
wherein the set of data includes a first set of data related to an autonomous vehicle that operated on a road and a second set of data related to one or more objects located in an environment where the autonomous vehicle operated,
wherein the set of data is associated with timestamps, and
wherein the set of data is received as part of a test performed with the software;
generating a plurality of frames using the timestamps associated with the set of data, wherein each frame includes at least one data from the set of data, and wherein each frame is associated with a unique timestamp;
determining, for each frame, that the at least one data indicates information related to the autonomous vehicle and/or the one or more objects;
assigning, for each frame, a label associated with the information indicated by the at least one data; and
displaying, using a graphical user interface (GUI) and for the test performed with the software, at least one label associated with at least one information in a frame.

2. The method of claim 1,
wherein the first set of data is associated with the autonomous vehicle that is operated on the road in a simulation, and
wherein the second set of data is associated with the one or more objects that are simulated in the simulation.

3. The method of claim 1, further comprising:
determining that the software is validated upon determining that a driving related operation of the autonomous vehicle indicated by the at least one label in the frame is a same as or meets a pre-determined performance requirement.

4. The method of claim 1, further comprising:
determining that the information indicated by the at least one data in each frame is associated with a static label or a dynamic label, wherein the label for the information is assigned based on whether the information is associated with the static label or the dynamic label.

5. The method of claim 4, wherein in response to the information being associated with the static label, the label for the information is assigned by determining that the information in the frame is described by or related to a first rule from a database that stores the label and the first rule associated with the label.

6. The method of claim 5, wherein the label for the information associated with the static label is assigned without performing a simulation with a scenario.

7. The method of claim 4, wherein in response to the information being associated with the dynamic label, the label for the information is assigned by determining that the information in at least two frames comprising the frame is described by or related to a second rule from a database that stores the label and the second rule associated with the label.

8. The method of claim 4, wherein the label for the information is assigned using computation resources that are assigned based on whether the information indicated by the at least one data in each frame is associated with the static label or the dynamic label.

9. The method of claim 8, wherein a number of the computation resources assigned for the information associated with the static label is less than that assigned for the information associated with the dynamic label.

10. An apparatus for autonomous vehicle operation comprising a processor, configured to implement a method, comprising:
receiving, by a computer, a set of data from a software that performs driving related operations for an autonomous vehicle,
wherein the set of data includes a first set of data related to an autonomous vehicle that operated on a road and a second set of data related to one or more objects located in an environment where the autonomous vehicle operated,
wherein the set of data is associated with timestamps, and
wherein the set of data is received as part of a test performed with the software;
generating a plurality of frames using the timestamps associated with the set of data, wherein each frame includes at least one data from the set of data, and wherein each frame is associated with a unique timestamp;
determining, for each frame, that the at least one data indicates information related to the autonomous vehicle and/or the one or more objects;
assigning, for each frame, a label associated with the information indicated by the at least one data; and
displaying, using a graphical user interface (GUI) and for the test performed with the software, at least one label associated with at least one information in a frame.

11. The apparatus of claim 10, wherein the at least one data in each frame is determined to include the information related to the autonomous vehicle and/or the one or more objects by performing keyword search on the at least one data in each frame.

12. The apparatus of claim 10, wherein the first set of data include driving related operations of the autonomous vehicle.

13. The apparatus of claim 10, wherein the second set of data related to at least one object includes a speed of the at least one object, a location of the at least one object, or a distance from the autonomous vehicle of the at least one object.

14. A non-transitory computer readable program storage medium having code stored thereon, the code, when executed by a processor, causing the processor to implement a method, comprising:
receiving, by a computer, a set of data from a software that performs driving related operations for an autonomous vehicle,
wherein the set of data includes a first set of data related to an autonomous vehicle that operated on a road and a second set of data related to one or more objects located in an environment where the autonomous vehicle operated,
wherein the set of data is associated with timestamps, and
wherein the set of data is received as part of a test performed with the software;
generating a plurality of frames using the timestamps associated with the set of data, wherein each frame includes at least one data from the set of data, and wherein each frame is associated with a unique timestamp;
determining, for each frame, that the at least one data indicates information related to the autonomous vehicle and/or the one or more objects;
assigning, for each frame, a label associated with the information indicated by the at least one data; and
displaying, using a graphical user interface (GUI) and for the test performed with the software, at least one label associated with at least one information in a frame.

15. The non-transitory computer readable program storage medium of claim 14, wherein the method further comprises:
storing in a database a plurality of labels and a plurality of rules, wherein each label is stored with a corresponding rule that indicates a content of a data or a pattern of the data associated with that label.

16. The non-transitory computer readable program storage medium of claim 14, wherein the method further comprises:
determining, from the plurality of frames, a set of frames that comprise a topic indicative of a driving related operation of the autonomous vehicle.

17. The non-transitory computer readable program storage medium of claim 14, wherein the method further comprises:
determining, from the plurality of frames, a set of frames that comprise a topic indicative of a driving related operation of a vehicle located in the environment where the autonomous vehicle operated.

18. The non-transitory computer readable program storage medium of claim 14, wherein the method further comprises:
determining, from the plurality of frames, a set of frames that comprise a topic indicative of a characteristic of an object located in the environment where the autonomous vehicle operated, wherein the one or more objects comprise the object.

19. The non-transitory computer readable program storage medium of claim 14, wherein the method further comprises:
determining, from the plurality of frames, a set of frames that comprise a topic indicative of a characteristic of the road on which the autonomous vehicle operated.

20. The non-transitory computer readable program storage medium of claim 14, wherein the method further comprises:
determining that a set of information related to an object from the one or more objects is related to another set of information related to the object in another frame.
